(19) United States
(12) Patent Application Publication
(10) Pub. No.: US 2026/0205486 A1
(43) Pub. Date: Jul. 16, 2026

(54) CYBERSECURITY ANOMALY DETECTION SYSTEM

(71) Applicants: Raytheon Company, Arlington, VA (US); Blue Canyon Technologies LLC, Lafeyette, CO (US)

(72) Inventors: Richard Reper, Golden, CO (US); Steven J. Austin, SR., Aubrey, TX (US); Brian Rosenberg, San Diego, CA (US); Michael J. Worden, Aurora, CO (US)

(21) Appl. No.: 19/017,048

(22) Filed: Jan. 10, 2025

(51) Int. Cl. H04L 9/40; G06V 10/764

(52) U.S. Cl. CPC H04L 63/1433; G06V 10/764

(57) ABSTRACT

Systems, devices, methods, and computer-readable media for device security are provided. A vehicle can include a power system, a positioning system, a weather sensor, processing circuitry, flight software communicatively coupled to the power system, the positioning system, the sensor, and the processing circuitry, the flight software configured to receive telemetry data from the power system, the positioning system, the sensor, and the processing circuitry, and an intrusion detection system (IDS) (i) configured to convert the telemetry data to an image and (ii) including a convolutional neural network (CNN) configured to receive the image and generate a classification based on the image, the classification indicating whether the telemetry data in the image corresponds to anomalous behavior.

### TECHNICAL FIELD

Aspects regard anomaly detection systems that can operate reliably on vehicles, including space vehicles, and other platforms, such as memory-limited platforms. The anomaly detection system uses object telemetry data to generate an image that is then processed by a machine learning (ML) model to identify an anomaly.

### BACKGROUND

Space vehicles, such as satellites, cargo space vehicles, crewed spacecraft, or the like, typically have limited memory and processing bandwidth. Space vehicles have intermittent communications capabilities and must prioritize conservation of power. The memory and processing bandwidth of the space vehicles is quickly consumed by necessary operations. There is little processing and memory capacity left over for performing intrusion detection. It would be beneficial to have an anomaly detection system that operates to provide reliable anomaly detection while consuming little processing and memory capacity in the process.

### BRIEF DESCRIPTION OF DRAWINGS

FIG. 1 illustrates, by way of example, a diagram of an embodiment of a system for anomaly detection.

FIG. 2 illustrates, by way of example, a flow diagram of a intrusion detection system (IDS) (e.g., an anomaly detection system).

FIG. 3 illustrates, by way of example, a diagram of an embodiment of a flow diagram of a system for training the Convolutional Neural Network (CNN).

FIG. 4 illustrates, by way of example, a diagram of an embodiment of the CNN that consumes low memory (less than 5 megabytes (MB)) and operates to accurately identify malicious activity.

FIG. 5 illustrates, by way of example, a diagram of an embodiment of a method for improved cybersecurity.

FIG. 6 is a block diagram of an example of an environment including a system for neural network (NN) training.

FIG. 7 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

The Space Development Agency (SDA) Risk Management Framework (RMF) requires space vehicles to have an intrusion detection system (IDS). Processing and memory capacity of a space vehicle are consumed in both detection of an anomalous sensor reading and reporting of the anomalous sensor reading. The amount of processing and memory capacity consumed depends on the complexity of an anomaly detection system that detects the anomalous sensor reading. The more complex and hardware intensive the anomaly detection system, the more power that is consumed by the anomaly detection system. The more data that is reported by the anomaly detection system, the more power that is consumed by the anomaly detection system. Space threats are evolving fast, now including intrusion vectors from other space vehicles. It would also be useful to have an anomaly detection system that provides suitable protection including power and connection state considerations. The IDS implemented in this patent consumes a fixed amount of processor and memory and can be tuned by the frequency of execution.

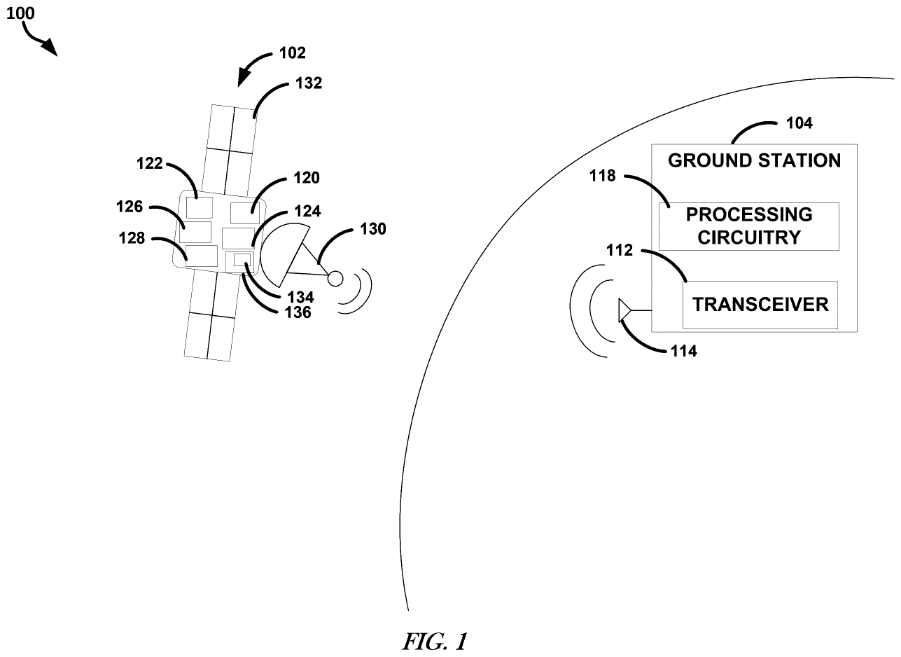

FIG. 1 illustrates, by way of example, a diagram of an embodiment of a system 100 for vehicle anomaly detection. The anomaly detection system described herein is well suited for space vehicles, but can also be used for a variety of other vehicles and platforms including autonomous cars, sea and land based vehicles and/or a resource constrained edge device. For discussion purposes, the system 100 is described with reference to a space vehicle 102, however, the described system and methods are applicable to other types of vehicles. The system 100 as illustrated includes a space vehicle 102 (illustrated in the form of a satellite) and a ground station 104. The space vehicle 102 as illustrated includes an antenna 130, power supply 132, sensor 120, transceiver 122, a positioning system 124, an inertial navigator 126, processing circuitry 136 that implements an intrusion detection data monitor 134, and a cryptography circuit 128.

The space vehicle 102, in the form of a satellite, can be a communication, remote sensing (e.g., weather, electromagnetic sensing, radar, lidar, or the like), navigation (e.g., global positioning system (GPS), Galileo, or the like), internet, radio, television, manned, unmanned, or other satellite. The space vehicle 102 is generally any device capable of communication with the ground station 104. The space vehicle 102 can be orbiting the Earth, whether in low Earth orbit (LEO), medium Earth orbit (MEO), geosynchronous Earth orbit (GEO) or high Earth orbit (HEO) or could be a naturally occurring celestial body external to the Earth.

The power supply 132 can include one or more batteries, nuclear power, solar panels, or a combination thereof. The state of the power supply 132 indicates how much power is available to the space vehicle 102. The power available indicates whether the space vehicle 102 has sufficient power to run IDS operations, such as monitoring telemetry data relevant to determining whether there is an anomaly by the monitor 134.

The transceiver 122 communicates, by wireless communication signals, data to and receives data from the ground station 104.

The positioning system 124 can include a GPS system, Galileo, or the like. The positioning system 124 can be spoofed and can be monitored for such spoofing.

The inertial navigator 126 provides additional location and navigation support along with the positioning system 124. The inertial navigator uses motion sensors (accelerometers), rotation sensors (gyroscopes) and a computer to continuously calculate by dead reckoning the position, the orientation, and the velocity (direction and speed of movement) of a moving object without the need for external references.

The cryptography circuit 128 encrypts communications to the ground station 104 and decrypts communications from the ground station 104. The cryptography circuit 128 is susceptible to attack and can be monitored for intrusion.

The intrusion detection data monitor 134 monitors the components of the space vehicle 102 for data that indicates there may be is an intrusion at the space vehicle 102. The data that potentially indicates there is an intrusion is data that is outside of nominal ranges, sometimes called an “anomaly”. The nominal ranges of a given sensor can be defined by a subject matter expert (SME), understood from historical observations, and learned by an ML model. The intrusion detection data monitor 134 can record the data, when it detects an anomaly through inference with a category of low probability, nominal, or other circumstance. The recorded data can be stored with a timestamp, an identifier that uniquely identifies the component that generated the data, or the like. The recorded data can be communicated to the ground station 104 when the satellite is in communication range and has sufficient power.

The intrusion detection data monitor 134 can receive telemetry data from various systems of the space vehicle. Telemetry data can include data from one or more of the antenna 130, power supply 132, transceiver 122, positioning system 124, inertial navigator 126, cryptography circuit 128, one or more sensors 120, or a combination thereof.

The space vehicle 102 as illustrated includes sensor(s) 120, transceiver 122, and an antenna 130. The transceiver 122 is a receive and transmit radio. The transceiver 122 receives electrical signals transduced by the antenna 130. The transceiver 122 can demodulate data from such signals. The transceiver 122 can modulate data onto electrical signals. The antenna 130 can convert the modulated electrical signals to an electromagnetic wave that is transmitted to the monitor 106. The data modulated onto the wave can include Keplerian element data or equivalent navigational content, as determined by the sensor(s) 120, a time as provided by a clock, data relevant for IDS operation, or a combination thereof. The clock of the space vehicle 102 is often an atomic clock with a very high time accuracy (e.g., with a maximum drift of about 2 nanoseconds a year). The sensor(s) 120 can include electro optical sensor(s) (e.g., visible, infrared (IR), or other electromagnetic radiation frequency sensor), three-axis accelerometer, gyroscope, temperature, weather, laser altimeter, lidar, radar, ranging instrument, scatterometer, sounder, radiometer, spectrometer, spectroradiometer, voltage, inertial measurement unit, sun sensor or photo detector, star tracker, and tamper or other hall sensor, or the like.

The ground station 104 as illustrated include a transceiver 112, processing circuitry 118, and an antenna 114. The transceiver 112 modulates data to be provided to the space vehicle 102 and receive electrical signals from the space vehicle 102. The processing circuitry 118 can include electrical components configured to perform the operations on the received data. The processing circuitry 118 can include one or more resistors, transistors, capacitors, diodes, inductors, logic gates (e.g., AND, OR, XOR, negate, buffer, or the like), regulators (e.g., voltage, current, or power), amplifiers, power supplies, analog to digital converters, digital to analog converters, multiplexers, switches, buck or boost converters, or the like. The processing circuitry 118 can include a processing unit, such as can include one or more central processing units (CPUs), graphics processing units (GPUs), field programmable gate arrays (FPGAs), application specific integrated circuits (ASICs), or the like. Two or more of the processing units can operate in different number systems, such as in parallel.

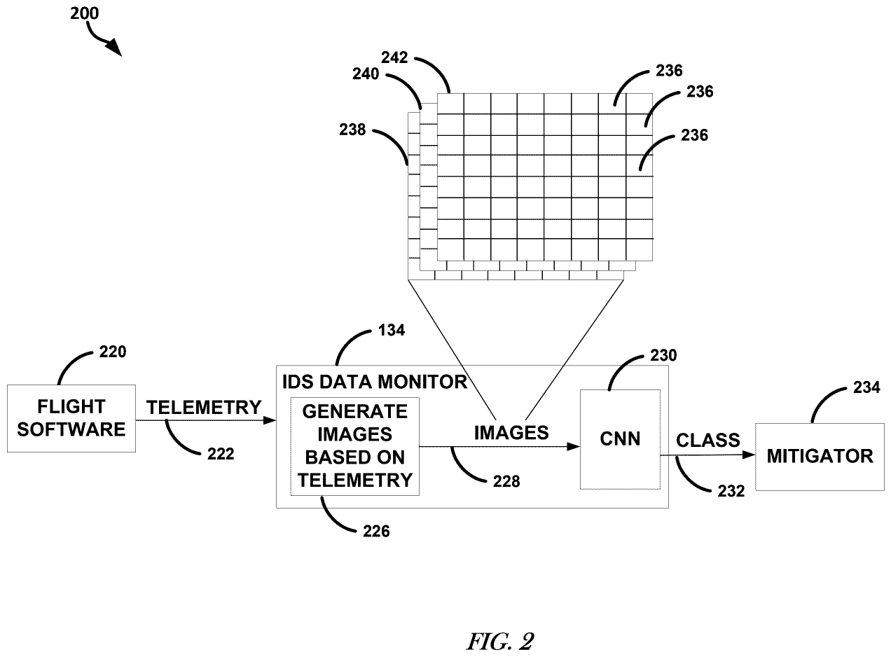

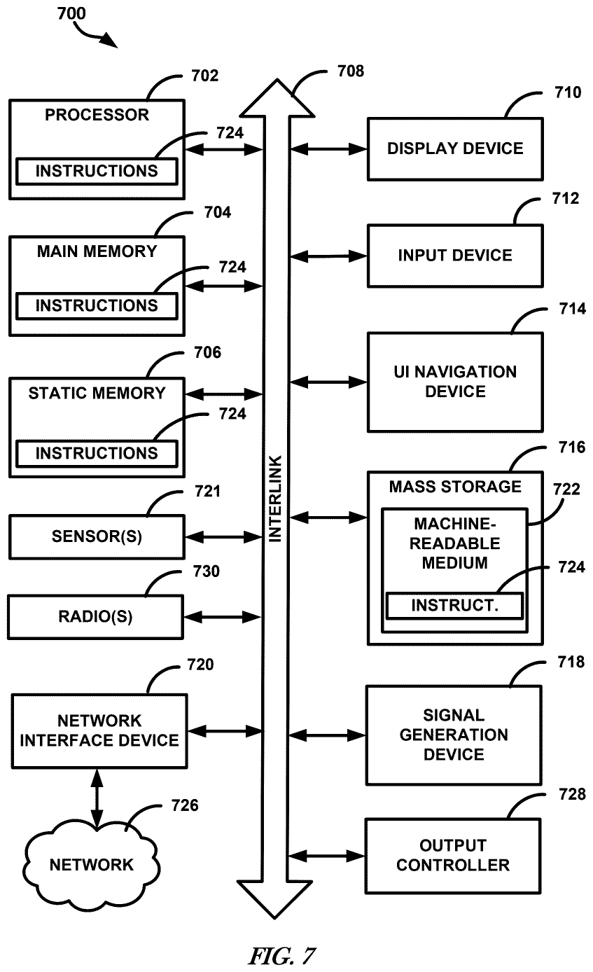

FIG. 2 illustrates, by way of example, a flow diagram of a system 200 for an improved anomaly detection system. The system 200 as illustrated includes flight software 220, IDS 224, CNN 230, and mitigator 234 of the space vehicle 102. The flight software 220 receives data from components of the space vehicle 102 that are relevant for IDS 224 operation. The data received from the components is called telemetry 222. The components can include power supply, sensor 120, communications, or other components of the space vehicle 102. The telemetry 222 can include power information, such as a voltage, frequency, amplitude, or the like of a power device, such as an inverter, solar panel, battery, or the like. The telemetry 222 can include communications data, such as a state (e.g., idle, connected, offline, or the like) of the antenna 130. The telemetry can include sensor data, such as can be indicative of an environment around the space vehicle 102, such as temperature, solar radiation, solar wind, solar particle events, or the like. The telemetry can include location data, such as from the GPS, inertial navigation system, or the like. The telemetry 222 can include data from an audit log of an operating system (OS) of the space vehicle 102. The telemetry 222 can include data from measurements of the state of the computational elements such as a memory (see FIG. 7) and CPU usage (e.g., the processing circuitry 136). For example, the telemetry 222 can include processing circuitry 136 (e.g., central processing unit (CPU)) usage, memory usage, a combination thereof, or the like.

The flight software 220 or the IDS 224 can transform the telemetry 222 data to a specified range. The specified range can be the range of values of a pixel 236 of an image 228. Note that not all pixels 236 are labelled in FIG. 2 so as to not obscure the view. Common pixel ranges include positive integer values between [0, 127], [0, 255], [0, 511], etc. Transforming the telemetry 222 data to a specified range is commonly called rescaling. If the sensor 120 produces output in a range [−100, 100] and the pixel range is eight bits, the output of the sensor 120 can be such that −100 maps to “0”, 100 maps to 255, and every value in between is rounded to map to a nearest integer according to new_value=(old_value+100)*255/200. This shows that shifting and scaling can be performed in transformation from the telemetry 222 to a pixel value.

The IDS 134 can generate, at operation 226, a series of images based on a series of telemetry 222 data. The telemetry 222 data is rescaled as discussed previously. Then each piece of quantized telemetry data is used as a pixel value in the image 228. Note that each image 228, as illustrated in FIG. 2, includes a grid of 8×8 pixels, but other image sizes are possible, and even likely, such as a grid of 32×32 pixels. The grid size can depend on the number of pieces of scaled quantized telemetry data to be used, an amount of memory available to hold the image pixel data, or a combination thereof. The grid size can be set to include all pieces of scaled telemetry data, constrained by a maximum amount of memory available for storing images over a specified period of time (e.g., a maximum amount of time between downlinks to the ground station 104).

Each image 238, 240, 242 of the series of images 228 can correspond to telemetry 222 collected in a specified period of time. Typically telemetry is collected at a specified frequency, such as 5 Hertz (or other frequency). In such instances, the telemetry 222 in the image 238, 240, 242 corresponds to the telemetry collected in a ⅕ second time window. The image 238 can include telemetry 222 data for a first time window, the image 240 can include telemetry 222 data for a second, immediately subsequent time window, and the image 242 can include telemetry 222 data for a third, immediately subsequent time window. Each of the three images 238, 240, 242 can be treated as a different corresponding color image of an overall red, green, blue (RGB) image.

The convolutional neural network (CNN) 230 can be trained to classify color images 228. The CNN 230 can receive three images 238, 240, 242 and determine a classification 232 based on the three images 238, 240, 242. The classification 232 can be a binary classification (e.g., indicating whether the telemetry 222 data is nominal or abnormal) or a more specific classification, such as can indicate a more specific type of anomaly. Anomaly types can include high memory usage, high processor usage, decryption failure, an invalid packet (e.g., a Consultative Committee for Space Data Systems (CCSDS) packet), high payload process load, or the like.

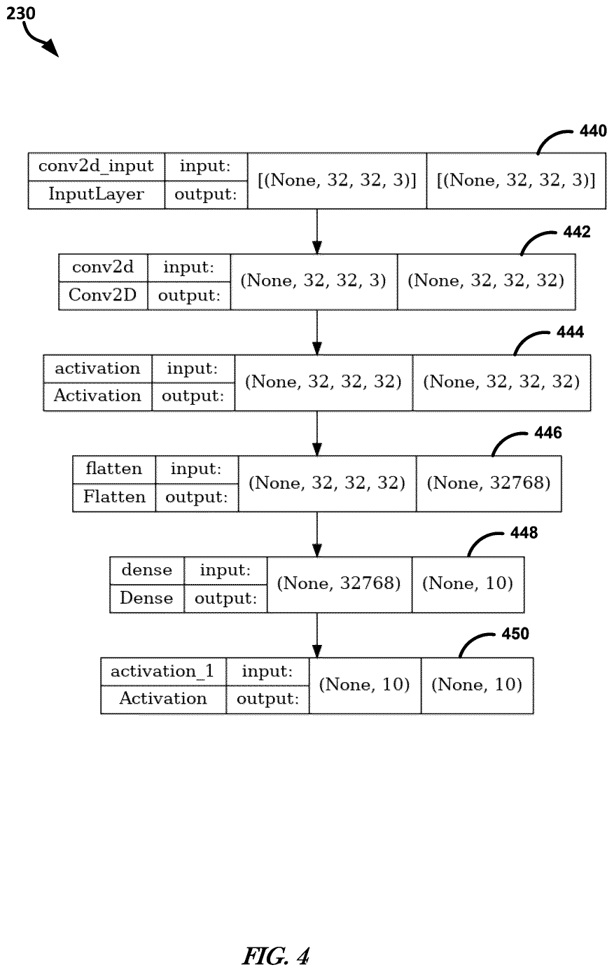

The CNN 230 is a type of artificial neural network (ANN) that is designed for image recognition and processing. A specific CNN architecture that can be used for reliable telemetry classification in a space vehicle is provided in and discussed in more detail regarding FIG. 4.

The classification 232 can be provided to a mitigator component 234. The mitigator component 234 can perform a mitigation operation that reduces or eliminates a threat to the space vehicle 102 posed by a detected anomaly. There are many mitigation actions that can be performed by the mitigator 234. Example mitigation actions include terminating a process that is operating on the space vehicle 102, altering a connectivity state of the antenna 130, resetting a component, such as a power supply, navigation component, sensor, or the like, of the space vehicle 102.

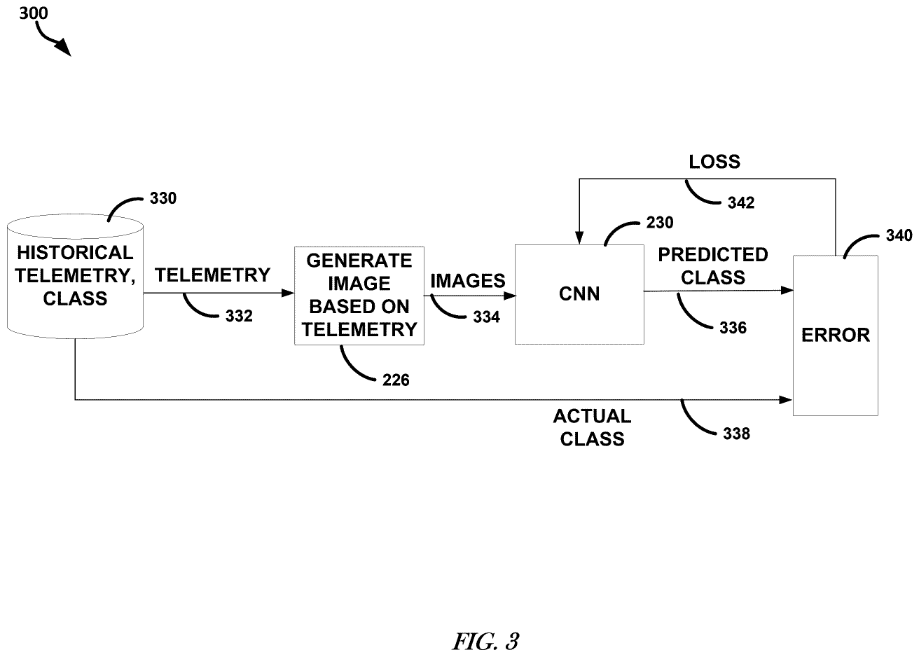

FIG. 3 illustrates, by way of example, a diagram of an embodiment of a flow diagram of a system 300 for training the CNN 230. The system 300 as illustrated includes historical telemetry data 330 and known classes. The telemetry 332 is the same as the telemetry 222, with the telemetry 332 being collected earlier in time than the telemetry 222 and having a known classification 338. The operation 226 can be performed based on the telemetry 332 to generate a series of images 334. Every three consecutive images can be treated as an RGB image and input into the CNN 230. The CNN 230 determines a predicted class 336 for each of three consecutive images 334. Note the images classified in a first iteration of classification by the CNN 230 can overlap with the images classified in a second, immediately subsequent iteration. If there are three images input for each predicted class 336, the images of subsequent iterations can overlap by zero, one, or two images. That is, if the series of images include {I₀, I₁, I₂} where Iₜ are respective images at respective time intervals t. for a first iteration of classification, the second iteration of classification can include {I₁, I₂, I₃}, {I₂, I₃, I₄}, or {I₃, I₄, I₅}. The inference performed by the CNN 230 after training can include similar overlap in images.

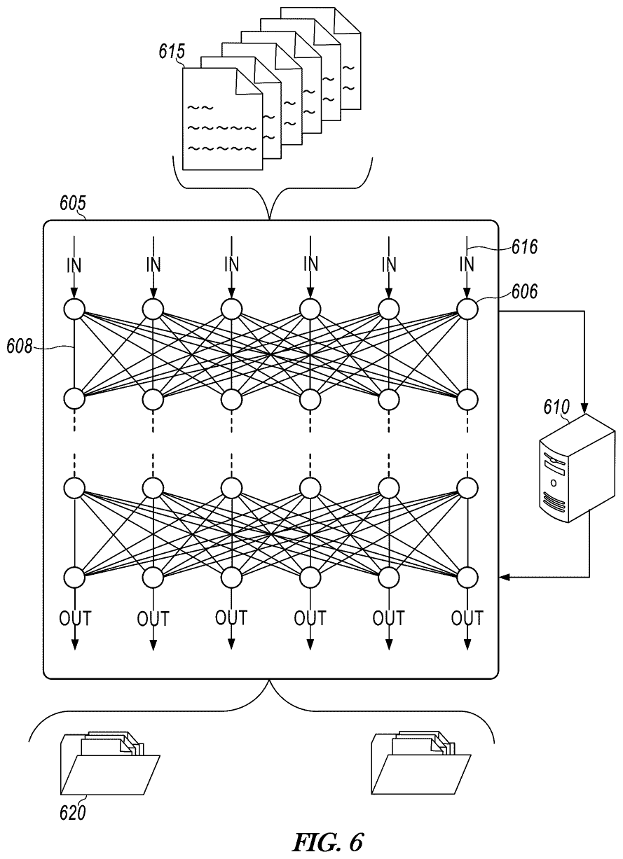

An error operator 340 can receive the predicted class 336 and the actual class 338. The error operator 340 determines a loss 342 based on a difference between the predicted class 336 and the actual class 338. The loss can include cross-entropy loss, mean squared error loss, categorical cross-entropy loss, hinge loss, or the like. The loss 342 is used to alter weights or other parameters of the CNN 230 to increase an accuracy of the predicted class 336. More details regarding NN training are provided regarding FIG. 6. The system 300 generates a trained CNN 230 that can be used for IDS in the space vehicle 102.

FIG. 4 illustrates, by way of example, a diagram of an embodiment of the CNN 230 that consumes low memory (less than 5 megabytes (MB)) and operates to accurately identify malicious activity. The CNN 230 as illustrated includes a convolutional, two-dimensional (2D) input layer 440, a convolutional 2D layer 442, an activation layer 444, a flatten layer 446, a densely connected layer 448, and an activation layer 450. Dimensions of the layers are provided, and are merely example dimensions that produce a model that consumes only 3 MB of memory and still operates to generate a sufficiently accurate (e.g., SME defined) prediction.

The input layer 440 includes the image data. The input layer 440 reshapes the image data. The convolutional 2D layer 442 is sometimes called a feature extraction layer. The layer 442 determines a convolution of the reshaped image data from the input layer. The activation layer 444, 450 learns and approximates a relationship between variables (e.g., features) of the CNN 230. The activation layer 444, 450 determines which information of the CNN 230 fires in the forward direction, such as by adding a non-linearity to the network. ReLU, SoftMax, tanH, and sigmoid are common functions that are approximated by the activation layer 444, 450. The flatten layer 446 converts an array into a single vector. The densely connected layer 448, sometimes called a fully connected layer, connects neurons from one layer to another layer. The layer 448 is used to classify images between different categories.

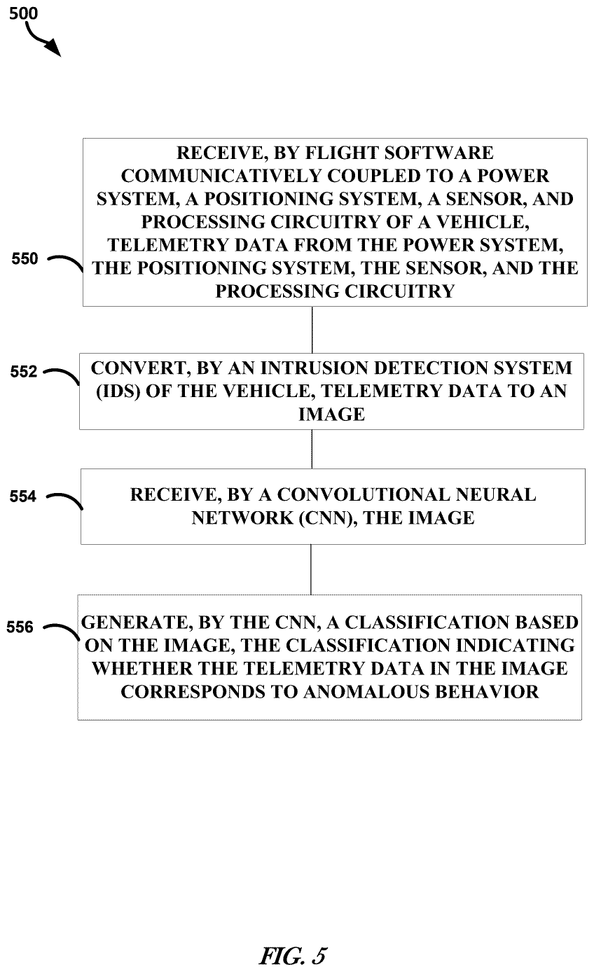

FIG. 5 illustrates, by way of example, a diagram of an embodiment of a method 500 for improved device security. For simplicity, the method 500 is discussed with reference to a space vehicle, but as discussed earlier, the methods and techniques described herein are applicable to other types of vehicles and objects. The method 500 as illustrated includes receiving, by flight software communicatively coupled to a power system, a positioning system, a sensor, and processing circuitry of the space vehicle, telemetry data from the power system, the positioning system, the sensor, and the processing circuitry, at operation 550; converting, by an intrusion detection system (IDS) of the space vehicle, telemetry data to an image, at operation 552; receiving, by a convolutional neural network (CNN), the image, at operation 554; and generating, by the CNN, a classification based on the image, the classification indicating whether the telemetry data in the image corresponds to anomalous behavior, at operation 556.

The method 500 can further include performing, by a mitigation operator of the space vehicle, a mitigation action to abate the anomalous behavior. The mitigation action can include resetting or removing power to a component of the space vehicle. The image can include first, second, and third image portions, each image portion corresponding to a different timeframe of telemetry data collection. The second image portion can correspond to a timeframe immediately subsequent a time frame of the first image portion.

The CNN can consume less than three megabytes of a memory of the space vehicle. The method 500 can further include receiving, by the flight software, further telemetry data from an operating system of the space vehicle. The method 500 can further include converting, by the IDS, the further telemetry data to the image along with the telemetry data.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The NN 300, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent (e.g., a stochastic gradient descent) technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 606 within layers. Thus, a set of processing nodes is arranged to perform the training of the ANN 605. The CNN 230, another component, or a component thereof can be trained using the system of FIG. 6.

The set of processing nodes is arranged to receive a training set 615 for the ANN 605. The ANN 605 comprises a set of nodes 606 arranged in layers (illustrated as rows of nodes 1406) and a set of inter-node weights 1408 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 616 to be classified after ANN 605 is trained, is provided to a corresponding node 606 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 616 will be assigned into categories), for example. The training performed by the set of processing nodes 606 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The different members of the set of processing nodes may be located in different packages, housings, computers, cloud-based resources, etc. In an example, each iteration of the training is performed independently between nodes in the set of nodes. This example is an additional parallelization whereby individual nodes 1406 (e.g., neurons) are trained independently. In an example, the nodes are trained on different hardware.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

FIG. 7 illustrates, by way of example, a block diagram of an embodiment of a machine in the example form of a computer system 700 within which instructions, for causing the machine to perform any one or more of the methodologies discussed herein, may be executed. One or more of the components of the space vehicle 102, the ground station 104, the method 400, or a component thereof can be implemented using, or can include the system 700 or a component thereof. Components of the space vehicle 102 include an antenna 130, power supply 132, sensor 120, transceiver 122, a positioning system 124, an inertial navigator 126, an intrusion detection data monitor 134, and a cryptography circuit 128. Components of the ground station 104 include the processing circuitry 118, the transceiver 112, and the antenna 114. One or more of the flight software 220, mitigation operator 234, error operator 340, method 500, or a component or operation thereof can be implemented or performed by the computer system 700. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 721 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 704 and a static memory 706, which communicate with each other via a bus 708. The memory 704, 706 can store parameters (sometimes called weights) that define operations of the processing circuitry 118, monitor 134, CNN 230, or other component of the system 700. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker), a network interface device 720, and radios 730 such as Bluetooth, WWAN, WLAN, and NFC, permitting the application of security controls on such protocols. Note that a space vehicle does not typically include a display, UI navigation device, or the like.

The machine 700 as illustrated includes an output controller 728. The output controller 728 manages data flow to/from the machine 700. The output controller 728 is sometimes called a device controller, with software that directly interacts with the output controller 728 being called a device driver.

### Machine-Readable Medium

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704, the static memory 706, and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Example

Example 1 includes a vehicle comprising a power system, a positioning system, a sensor, processing circuitry, flight software communicatively coupled to the power system, the positioning system, the sensor, and the processing circuitry, the flight software configured to receive telemetry data from the power system, the positioning system, the sensor, and the processing circuitry, and an intrusion detection system (IDS) (i) configured to convert the telemetry data to an image and (ii) including a convolutional neural network (CNN) configured to receive the image and generate a classification based on the image, the classification indicating whether the telemetry data in the image corresponds to anomalous behavior.

In Example 2, Example 1 further includes a mitigation operator configured to perform a mitigation action to abate the anomalous behavior.

In Example 3, Example 2 further includes, wherein the mitigation action includes resetting or removing power to a component of the vehicle.

In Example 4, at least one of Examples 1-3 further includes, wherein the image includes first, second, and third image portions, each image portion corresponding to a different timeframe of telemetry data collection.

In Example 5, Example 4 further includes, wherein the second image portion corresponds to a timeframe immediately subsequent a time frame of the first image portion.

In Example 6, at least one of Examples 1-5 further includes, wherein the CNN consumes less than three megabytes of a memory of the vehicle.

In Example 7, at least one of Examples 1-6 further includes an operating system, wherein the flight software further receives further telemetry data from the operating system and the IDS converts the further telemetry data to the image along with the telemetry data.

In Example 8, at least one of Examples 1-7 further includes, wherein the vehicle comprises one of a space vehicle, land vehicle, sea vehicle or a resource constrained edge device.

Example 9 includes a method for vehicle intrusion detection, the method comprising receiving, by flight software communicatively coupled to a power system, a positioning system, a sensor, and processing circuitry of the vehicle, telemetry data from the power system, the positioning system, the sensor, and the processing circuitry, converting, by an intrusion detection system (IDS) of the vehicle, telemetry data to an image, receiving, by a convolutional neural network (CNN), the image, and generating, by the CNN, a classification based on the image, the classification indicating whether the telemetry data in the image corresponds to anomalous behavior.

In Example 10, Example 9 further includes performing, by a mitigation operator of the vehicle, a mitigation action to abate the anomalous behavior.

In Example 11, Example 10 further includes, wherein the mitigation action includes resetting or removing power to a component of the vehicle.

In Example 12, at least one of Examples 9-11 further includes, wherein the image includes first, second, and third image portions, each image portion corresponding to a different timeframe of telemetry data collection.

In Example 13, Example 12 further includes, wherein the second image portion corresponds to a timeframe immediately subsequent a time frame of the first image portion.

In Example 14, at least one of Examples 9-13 further includes, wherein the CNN consumes less than three megabytes of a memory of the vehicle.

In Example 15, at least one of Examples 9-14 further includes receiving, by the flight software, further telemetry data from an operating system of the vehicle, and converting, by the IDS, the further telemetry data to the image along with the telemetry data.

In Example 16, at least one of Examples 9-15 further includes, wherein the vehicle comprises one of a space vehicle, land vehicle, sea vehicle or a resource constrained edge device.

Example 17 includes a non-transitory machine-readable medium including instructions that, when executed by a machine, cause the machine to perform the method of at least one of one of Examples 9-16.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A vehicle comprising:
a power system;
a positioning system;
a sensor;
processing circuitry;
flight software communicatively coupled to the power system, the positioning system, the sensor, and the processing circuitry, the flight software configured to receive telemetry data from the power system, the positioning system, the sensor, and the processing circuitry; and
an intrusion detection system (IDS) (i) configured to convert the telemetry data to an image and (ii) including a convolutional neural network (CNN) configured to receive the image and generate a classification based on the image, the classification indicating whether the telemetry data in the image corresponds to anomalous behavior.

2. The vehicle of claim 1, further comprising a mitigation operator configured to perform a mitigation action to abate the anomalous behavior.

3. The vehicle of claim 2, wherein the mitigation action includes resetting or removing power to a component of the vehicle.

4. The vehicle of claim 1, wherein the image includes first, second, and third image portions, each image portion corresponding to a different timeframe of telemetry data collection.

5. The vehicle of claim 4, wherein the second image portion corresponds to a timeframe immediately subsequent a time frame of the first image portion.

6. The vehicle of claim 1, wherein the CNN consumes less than three megabytes of a memory of the vehicle.

7. The vehicle of claim 1, further comprising an operating system, wherein the flight software further receives further telemetry data from the operating system and the IDS converts the further telemetry data to the image along with the telemetry data.

8. The vehicle of claim 1, wherein the vehicle comprises one of a space vehicle, land vehicle, sea vehicle or a resource constrained edge device.

9. A method for vehicle intrusion detection, the method comprising:
receiving, by flight software communicatively coupled to a power system, a positioning system, a sensor, and processing circuitry of the vehicle, telemetry data from the power system, the positioning system, the sensor, and the processing circuitry;
converting, by an intrusion detection system (IDS) of the vehicle, telemetry data to an image;
receiving, by a convolutional neural network (CNN), the image; and
generating, by the CNN, a classification based on the image, the classification indicating whether the telemetry data in the image corresponds to anomalous behavior.

10. The method of claim 9, further comprising performing, by a mitigation operator of the vehicle, a mitigation action to abate the anomalous behavior.

11. The method of claim 10, wherein the mitigation action includes resetting or removing power to a component of the vehicle.

12. The method of claim 9, wherein the image includes first, second, and third image portions, each image portion corresponding to a different timeframe of telemetry data collection.

13. The method of claim 12, wherein the second image portion corresponds to a timeframe immediately subsequent a time frame of the first image portion.

14. The method of claim 9, wherein the CNN consumes less than three megabytes of a memory of the vehicle.

15. The method of claim 9, further comprising:
receiving, by the flight software, further telemetry data from an operating system of the vehicle; and
converting, by the IDS, the further telemetry data to the image along with the telemetry data.

16. The method of claim 9, wherein the vehicle comprises one of a space vehicle, land vehicle, sea vehicle or a resource constrained edge device.

17. A non-transitory machine-readable medium including instructions that, when executed by a machine, cause the machine to perform operations for intrusion detection in a vehicle, the operations comprising:
receiving, by flight software communicatively coupled to a power system, a positioning system, a sensor, and processing circuitry of the vehicle, telemetry data from the power system, the positioning system, the sensor, and the processing circuitry;
converting, by an intrusion detection system (IDS) of the vehicle, telemetry data to an image;
receiving, by a convolutional neural network (CNN), the image; and
generating, by the CNN, a classification based on the image, the classification indicating whether the telemetry data in the image corresponds to anomalous behavior.

18. The non-transitory machine-readable medium of claim 17, wherein the operations further comprise performing, by a mitigation operator of the vehicle, a mitigation action to abate the anomalous behavior.

19. The non-transitory machine-readable medium of claim 18, wherein the mitigation action includes resetting or removing power to a component of the vehicle.

20. The non-transitory machine-readable medium of claim 17, wherein the image includes first, second, and third image portions, each image portion corresponding to a different timeframe of telemetry data collection.
